(19) United States
(12) Patent Application Publication
(10) Pub. No.: US 2009/0251097 A1
(43) Pub. Date: Oct. 8, 2009

(54) WIND POWER CHARGING DEVICES

(75) Inventor: Jung-Yen KUO, Yunlin County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/170,088

(22) Filed: Jul. 9, 2008

(30) Foreign Application Priority Data
Apr. 8, 2008 (TW) 097112630

(51) Int. Cl. H02J 7/00

(52) U.S. Cl. 320/101

(57) ABSTRACT

A wind power charging device for a portable electric apparatus is provided. The wind power charging device includes a fan, a power transformation device, a switching device, a rechargeable battery, and an output terminal. The fan rotates according to wind power and generates rotation power. The power transformation device transforms the rotation power to electric power. The switching device receives the electric power and outputs a first charging voltage. The rechargeable battery is charged by the first charging voltage and discharged to output a second charging voltage. The output terminal receives the first charging voltage and the second charging voltage and outputs a third charging voltage. The switching device selectively outputs the first charging voltage to one of the rechargeable battery or the output terminal.

### CROSS REFERENCE TO RELATED APPLICATIONS

This application claims the benefit of Taiwan application Serial No. 97112630 filed Apr. 8, 2008, the subject matter of which is incorporated herein by reference.

### BACKGROUND OF THE INVENTION

1. Field of the Invention

The invention relates to a wind power charging device, and more particularly to a wind power charging device with a rechargeable battery.

2. Description of the Related Art

When using mobile phones and portable MP3 players, users are often faced with loss of power due to low battery power and no alternate means for charging batteries. In order to deal with this situation, users must carry a backup battery or a battery charger. However, even if a user does carry a battery charger, a power supply source is required for charging. As such, if a user does not carry a backup battery but does carry a battery charger, loss of device power may still occur, if the user does not have access to a power supply source. Thus, a more convenient way for charging portable electric apparatuses such as mobile phones and portable MP3 players following loss of power is desired.

### BRIEF SUMMARY OF THE INVENTION

An exemplary embodiment of a wind power charging device for a portable electric apparatus is provided, comprising a fan, a power transformation device, a switching device, a rechargeable battery, and an output terminal. A fan receives wind power, rotates according to the wind power, and generates rotation power. The power transformation device is coupled to the fan and transforms the rotation power generated by the fan to electric power. The switching device is coupled to the power transformation device. The switching device receives the electric power and outputs a first charging voltage. The rechargeable battery is coupled to the switch device and receives the first charging voltage. The rechargeable battery is charged by the first charging voltage and discharged to output a second charging voltage. The output terminal is coupled the switching device and the rechargeable battery. The output terminal receives the first charging voltage and the second charging voltage and outputs a third charging voltage. The switching device selectively outputs the first charging voltage to one of the rechargeable battery or the output terminal

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exemplary embodiment of a wind power charging device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

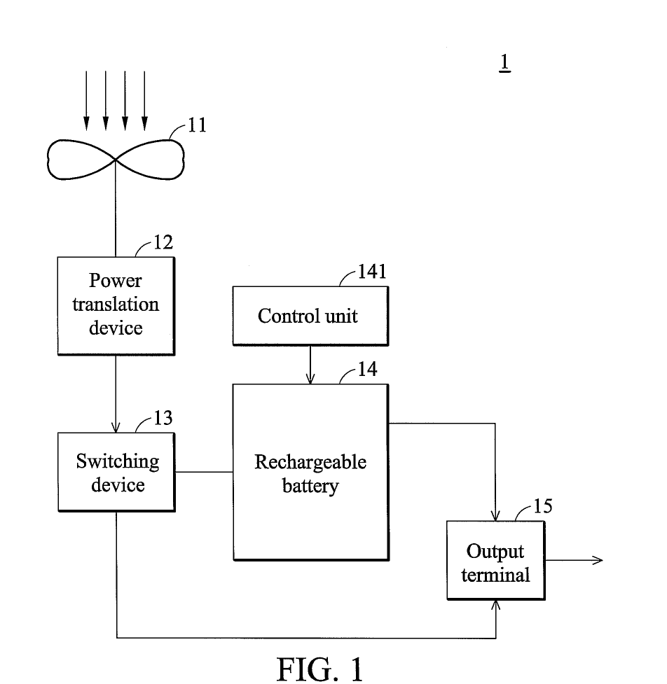

In an exemplary embodiment of a wind power charging device in FIG. 1, a wind power charging device 1 comprises a fan 11, a power transformation device 12, a switching device 13, a rechargeable battery 14, a control unit 141, and an output terminal 15.

The fan 11 receives wind power. The fan 11 rotates according to the wind power and generates rotation power to drive the power transformation device 12 coupled to the fan 11. The power transformation device 12 receives the rotation power generated by the fan 11 and transforms the rotation power to electric power for outputting. In this embodiment, the power transformation device 12 can be implemented by a generator.

The switching device 13 is coupled to the power transformation device 12 and receives the electric power output from the power transformation device 12. The switching device 13 selects a path to output a first charging voltage. The switching device 13 has a function of switching paths, so that the switching device 13 can selectively output the first charging voltage to the rechargeable battery 14 or the output terminal 15. In some embodiments, the switching device 13 can be artificially controlled through an external operating unit by users.

The rechargeable battery 14 is coupled to the switching device 13 and receives the first charging voltage output from the switching device 13. The rechargeable battery 14 is charged by the first charging voltage. The rechargeable battery 14 is further coupled to the control unit 141 which controls the rechargeable battery 14 to be charged or discharged. When the control unit 141 controls the rechargeable battery 14 to be charged, the rechargeable battery 14 is charged by the first charging voltage output from the switching device 13. When the control unit 141 controls the rechargeable battery 14 to be discharged, the rechargeable battery 14 outputs a second charging voltage to the output terminal 15. In some embodiments, the control unit 141 can be artificially controlled through an external operating unit by users.

The output terminal 15 is coupled to the rechargeable battery 14 and the switching device 13. The output terminal 15 receives the first charging voltage output from the switching device 13 or the second charging voltage output from the rechargeable battery 14 and outputs a third charging voltage. When the switching device 13 selectively outputs the first charging voltage, the control unit 141 will not be able to control the rechargeable battery 14 to output the second charging voltage to the output terminal 15, to avoid receiving two charging voltages simultaneously.

The wind power charging device 1 of the invention can charge a portable (or mobile) electric apparatus as long as a suitable adapter is used. When a battery of the portable electric apparatus does not need to be charged and wind power is enough, the rechargeable battery 14 can be charged for storing back-up power. When the battery of the portable electric apparatus runs out and there is no power supply device, the wind power charging device 1 can charge the battery of the portable electric apparatus.

According to above description, the invention provides a more convenient way for charging portable electric apparatuses following loss of power.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wind power charging device for a portable electric apparatus, comprising
a fan for receiving wind power, rotating according to the wind power, and generating rotation power;
a power transformation device, coupled to the fan, for transforming the rotation power generated by the fan to electric power;
a switching device, coupled to the power transformation device, for receiving the electric power and outputting a first charging voltage;
a rechargeable battery, coupled to the switch device, for receiving the first charging voltage, wherein the rechargeable battery is charged by the first charging voltage and discharged to output a second charging voltage; and
an output terminal, coupled the switching device and the rechargeable battery, for receiving the first charging voltage and the second charging voltage and outputting a third charging voltage;
wherein the switching device selectively outputs the first charging voltage to one of the rechargeable battery or the output terminal.

2. The wind power charging device as claimed in claim 1, wherein the power transformation device is implemented by a generator.

3. The wind power charging device as claimed in claim 1, wherein the switching device selectively outputs the first charging voltage to the rechargeable battery, the rechargeable battery is charged by the first charging voltage.

4. The wind power charging device as claimed in claim 1 further comprising a control unit, coupled to the rechargeable battery, for controlling the rechargeable battery to be charged by the first charging voltage or outputting the second charging voltage.
